(19) United States
(12) Patent Application Publication
(10) Pub. No.: US 2026/0319100 A1
(43) Pub. Date: Oct. 15, 2026

(54) NON-TERRESTRIAL NETWORK (NTN) USER EQUIPMENT (UE) POSITIONING WITH LIMITED NUMBER OF SATELLITES

(71) Applicant: QUALCOMM Incorporated, San Diego, CA (US)

(72) Inventors: Yuxiang PENG, San Jose, CA (US); Weimin DUAN, San Diego, CA (US)

(21) Appl. No.: 19/719,133

(22) Filed: Jun. 24, 2026

Related U.S. Application Data
(63) Continuation of application No. 18/171,166, filed on Feb. 17, 2023.

(51) Int. Cl. G01S 19/07; G01S 19/12; G01S 19/25

(52) U.S. Cl. CPC G01S 19/071; G01S 19/12; G01S 19/25

(57) ABSTRACT

A method of supporting multi-epoch double-differenced ranging (MEDDR) to position a user equipment (UE) in a wireless communication network may comprise receiving a request message at a reference station, indicative of a request for positioning of the UE. The method may comprise sending a response message to a server, responsive to the request message, the response message comprising a location of the reference station. The method may comprise receiving configuration data from the server regarding the positioning of the UE. The method may comprise performing pseudorange measurements at a first time and a second time in accordance with the configuration data, wherein the second time is at least a threshold duration of time after the first time. The method may comprise sending information indicative of the pseudorange measurements to the server, the UE, or both.

### RELATED APPLICATIONS

This application is a continuation of U.S. application Ser. No. 18/171,166, filed Feb. 17, 2023, entitled “NON-TERRESTRIAL NETWORK (NTN) USER EQUIPMENT (UE) POSITIONING WITH LIMITED NUMBER OF SATELLITES,” which is assigned to the assignee hereof, and incorporated herein in its entirety by reference.

### BACKGROUND

### 1. Field of Disclosure

The present disclosure relates generally to the field of wireless communications, and more specifically to the position determination of an electronic device capable of wireless communications.

### 2. Description of Related Art

In a wireless communication network (e.g., a cellular network), a determination of a location of a mobile device, or user equipment (UE), traditionally has either been performed by the device itself (e.g., using a specialized global navigation satellite system (GNSS) satellite receiver) or been performed using geometric methods of position determination from measurements of RF signals using terrestrial transceivers (e.g., base stations) of the wireless communication network. As wireless communication networks expand to include non-terrestrial network (NTN) nodes, such as satellites, these networks have not only expanded the geographical regions in which the communication network is available, but also the possibilities of performing positioning of UEs.

### BRIEF SUMMARY

An example method of supporting multi-epoch double-differenced ranging (MEDDR) to position a user equipment (UE) in a wireless communication network, according to this disclosure, may comprise receiving a request message at a reference station, the request message indicative of a request for positioning of the UE. The method also may comprise sending a response message from the reference station to a server, responsive to the request message, the response message comprising a location of the reference station. The method also may comprise receiving configuration data at the reference station, the configuration data received from the server and regarding the positioning of the UE. The method also may comprise performing pseudorange measurements at the reference station, the pseudorange measurements performed at a first time and a second time, in accordance with the configuration data, wherein the second time is at least a threshold duration of time after the first time. The method also may comprise sending information indicative of the pseudorange measurements from the reference station to the server, the UE, or both.

An example reference station for supporting multi-epoch double-differenced ranging (MEDDR) to position a user equipment (UE) in a wireless communication network, according to this disclosure, may comprise a transceiver, a memory, and one or more processors communicatively coupled with the transceiver and the memory. The one or more processors may be configured to receive a request message via the transceiver at the reference station, the request message indicative of a request for positioning of the UE. The one or more processors further may be configured to send a response message via the transceiver to a server, responsive to the request message, the response message comprising a location of the reference station. The one or more processors further may be configured to receive configuration data via the transceiver at the reference station, the configuration data received from the server and regarding the positioning of the UE. The one or more processors further may be configured to perform pseudorange measurements with the transceiver, the pseudorange measurements performed at a first time and a second time, in accordance with the configuration data, wherein the second time is at least a threshold duration of time after the first time. The one or more processors further may be configured to send information indicative of the pseudorange measurements via the transceiver to the server, the UE, or both.

An example apparatus for supporting multi-epoch double-differenced ranging (MEDDR) to position a user equipment (UE) in a wireless communication network, according to this disclosure, may comprise means for receiving a request message at a reference station, the request message indicative of a request for positioning of the UE. The apparatus also may comprise means for sending a response message from the reference station to a server, responsive to the request message, the response message comprising a location of the reference station. The apparatus also may comprise means for receiving configuration data at the reference station, the configuration data received from the server and regarding the positioning of the UE. The apparatus also may comprise means for performing pseudorange measurements at the reference station, the pseudorange measurements performed at a first time and a second time, in accordance with the configuration data, wherein the second time is at least a threshold duration of time after the first time. The apparatus also may comprise means for sending information indicative of the pseudorange measurements from the reference station to the server, the UE, or both.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system, according to an embodiment.

FIG. 2 is a fifth generation (5G) new radio (NR) positioning system, which illustrates how some aspects of the positioning system of FIG. 1 may be implemented in a wireless network, according to an embodiment.

FIG. 3 is a message flow diagram illustrating a basic process of how assistance data may be delivered in positioning system, such as the one illustrated in FIGS. 1 and 2, according to an embodiment.

FIG. 4 is a graph illustrating aspects of a non-terrestrial network (NTN) system, according to an embodiment.

FIG. 5 is an illustration of a configuration in which multi-epoch double-differenced ranging (MEDDR) may be performed for user equipment (UE) positioning, according to an embodiment.

FIG. 6 is a message flow diagram of a procedure for supporting MEDDR-based positioning, according to an embodiment.

FIG. 7 is a flow diagram of a method 700 of MEDDR for positioning a UE in a wireless communication network, according to an embodiment.

FIG. 8 is a flow diagram of a method 800 of supporting MEDDR for positioning a UE in a wireless communication network, according to an embodiment.

FIG. 9 is a block diagram of an embodiment of a UE.

FIG. 10 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

As noted, wireless communication networks may include non-terrestrial network (NTN) nodes, such as look earth orbit (LEO) satellites, to expand network coverage to UEs in more geographical locations. Because such extension is just beginning, often there may only be one or two LEO satellites visible to a UE at any given time. As such, positioning using the and LEO satellites may be difficult because geometrical solutions for positioning often would require many LEO satellites. As such, positioning solutions using LEO satellites are limited.

Embodiments herein address these and other issues by enabling positioning of a UE as few as two LEO satellites comprising NTN nodes of a communication network (e.g., cellular network). Embodiments leverage the relative speed at which LEO satellites across the sky to provide spatial diversity for positioning over two or more epochs, and double differencing between measurements taken at a UE and a reference station, to provide accurate positioning of the UE. Embodiments herein may be generally referred to as multi-epoch double-differenced ranging (MEDDR).

Various aspects relate generally to positioning of a UE using NTN nodes, such as LEO satellites. Some aspects more specifically relate to using two or more sets of measurements taken at two or more respective times to determine pseudoranges between two or more satellites and each of the UE and a reference station. In some examples, each epoch (or measurement time) may take place after at least a threshold duration from the previous epoch, to help ensure spatial diversity for the determination of the position of the UE. In some examples, the reference station may comprise another UE (e.g., with a known location), a base station, or other device. In some examples, coordination of measurements by the UE and reference station may be provided by location server, which can provide a configuration to the UE and/or reference station.

Particular aspects of the subject matter described in this disclosure can be implemented to realize one or more of the following potential advantages. In some examples, by using LEO satellites (which move relatively quickly compared with other types of satellites), the described techniques can be used to perform multi-epoch positioning of the UE in a relatively short amount of time. Further, power and/or bandwidth efficiencies may be realized by coordinating the transmission and/or receipt of RF signals to perform the measurements from which pseudoranges are determined. These and other aspects will be apparent to a person of ordinary skill in the art from the embodiments described herein. Embodiments are described in detail hereafter, following a description of relevant technology.

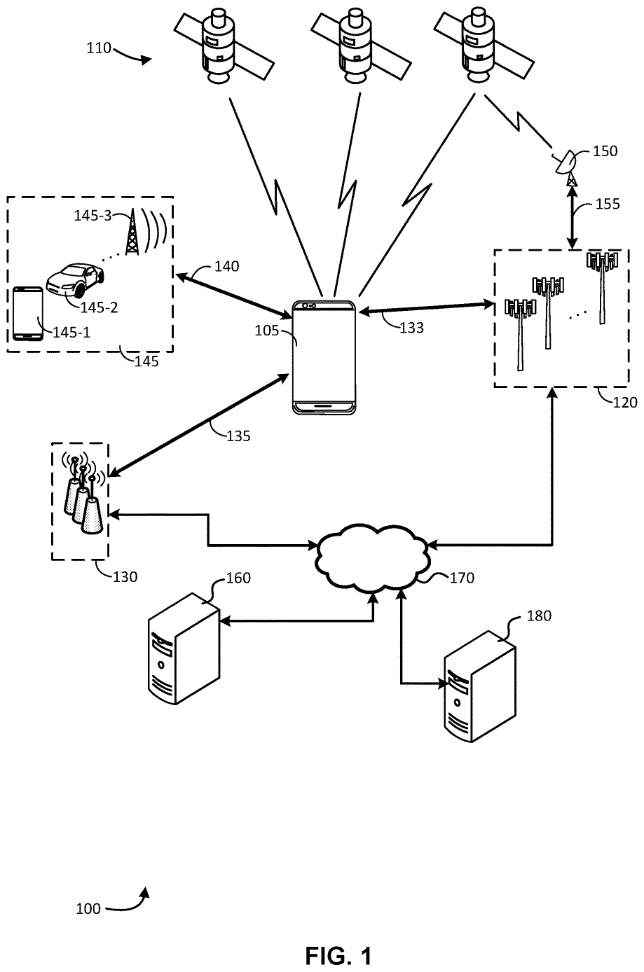

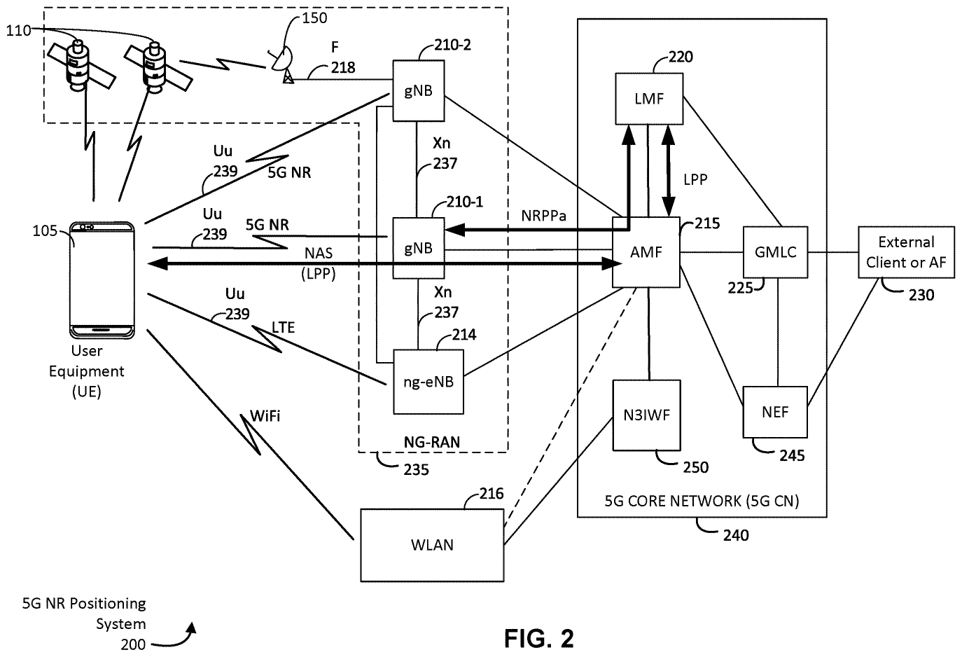

FIG. 1 is a simplified illustration of a positioning system 100 in which a UE 105, location server 160, and/or other components of the positioning system 100 can use the techniques provided herein for determining an estimated location of UE 105 using MEDDR, according to an embodiment. The techniques described herein may be implemented by one or more components of the positioning system 100, however the techniques described herein are not limited to such components and may be implemented in other types of systems (not shown). The positioning system 100 can include: a UE 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the UE 105 to communicate with the network 170 via satellites 110, but this can also enable network-based positioning, RF sensing, etc.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards.

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning system 200 are described below. The 5G NR positioning system 200 may include additional or alternative components.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, WLAN 216, or NTN satellite 110) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such gNB 210, ng-eNB 214, WLAN 216, or NTN satellite 110, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network-based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, which is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

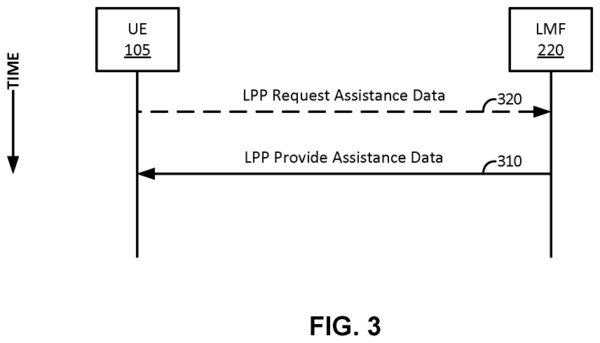

As noted, techniques for performing positioning of a UE 105 may involve the LMF 220 providing the UE 105 with assistance data. Such assistance data may be provided in accordance with LPP protocol, and may be provided in different ways, depending on the scenario. FIG. 3 illustrates how assistance data may be provided.

FIG. 3 is a message flow diagram illustrating a basic process of how assistance data may be delivered in a positioning system such as the one illustrated in FIG. 1 and FIG. 2 using LPP, according to some embodiments. The example provided in FIG. 3 illustrates messaging between a UE and LMF for NR positioning system (e.g., as illustrated in FIG. 2), although embodiments are not so limited. Additionally, the exchange in the example illustrated in FIG. 3 is done using LPP protocol, although, again, embodiments are not so limited. Alternative embodiments may be performed in different types of positioning systems and/or may use different protocols.

Assistance data may be exchanged in either UE-based or UE-assisted positioning. In UE-assisted positioning, the LMF 220 may determine that assistance data needs to be provided to the UE 105 (e.g., as part of a positioning procedure) and may send an LPP Provide Assistance Data message to the UE 105, as illustrated by arrow 310 in FIG. 3. On the other hand, in UE-based positioning, the UE may determine that certain positioning assistance data are desired (e.g., as part of a positioning procedure when the LMF provided assistance data are not sufficient for the UE to fulfil the request). In such instances, the UE 105 may send an LPP Request Assistance Data message to the LMF 220, as indicated by arrow 320 (where the dashed line illustrates optional functionality). The LMF 220 may then respond by providing the requested assistance in an LPP Provide Assistance Data message (shown by arrow 310), if available at the LMF 220. Additional details regarding LPP positioning, and NG-RAN positioning architecture are provided in 3GPP technical specifications (TS) 38.305 (e.g., sections 5 and 6) and 37.355 (e.g., section 4).

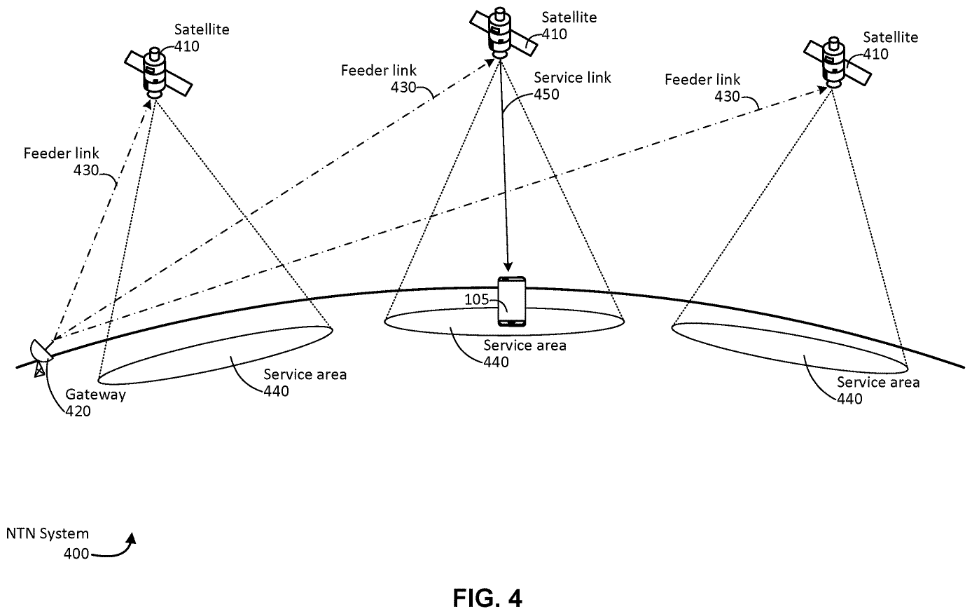

When performing positioning using NTN satellites (also referred to herein as “NTN positioning” or simply “NTN”), additional considerations may need to be made due to features implemented in NTN that are not found in terrestrial networks (TN). An overview of some of these features is provided in a FIG. 4.

FIG. 4 is a graph illustrating aspects of an NTN system 400, which may be utilized to communicate data and/or provide positioning of a UE 105 (which may correspond to UE 105 of FIGS. 1-3) and may be part of a larger communication and/or positioning system (e.g., as previously described with respect to FIGS. 1 and/or 2). It can be noted that, although the NTN system 400 illustrated in FIG. 4 illustrates satellites 410 for enabling communications and/or positioning of the UE 105, embodiments are not so limited. An NTN system 400 may additionally or alternatively include other non-terrestrial vehicles (not shown in FIG. 4), including non-space vehicles such as high-altitude platform stations, balloons, airplanes, drones, etc.

The use of satellites 410 and/or other non-terrestrial vehicles to relay communication signals and/or provide positioning for a UE 105 can help provide availability and continuity in geographical regions that may not otherwise be easily serviceable using terrestrial-only means. As noted, satellites 410 may include LEO, MEO, or GEO satellites, or a combination thereof. The satellites 410 (and/or other non-terrestrial vehicles in an NTN system 400) may connect with a 5G or other communication network via a gateway 420 (which may correspond with gateways 150 in FIGS. 1 and 2) or ground station using wireless RF feeder links 430. Satellites 410 may service corresponding service areas 440, which may be divided into one or more subregions, or “beams” (which may be elliptic in shape) and may establish a service link 450 with a UE within a corresponding service area 440. The service area 440 (and corresponding beams) may move, corresponding with the movement of the respective satellite 410 a long its orbit. Alternatively, the service area 440 (and corresponding beams) may be earth fixed, in such case some beam pointing mechanisms (mechanical or electronic steering feature) compensate for the satellite 410 (or the aerial vehicle) motion. (It can be noted that the notion of “satellite beam” in this context may be different than the concept of “beam” in NR FR2. Satellite beams, in some aspects, may be considered analogous to cells in a terrestrial network.) The service link 450 may serve as a Uu interface to the wireless network access to via the gateway 420. In some embodiments, the gateway 420 and/or satellites 410 may be associated with a base station of cellular network (e.g., gNB of a 5G network), and may comprise remote RUs and/or DUs of the base station, operatively functioning as TRPs, TPs, and/or RPs of the base station.

Positioning a UE 105 using an NTN system 400 may be similar to positioning in a cellular network (e.g., as previously described with regard to 5G NR positioning system 200 of FIG. 2). This can include, for example, the use of satellites 410 and/or other non-terrestrial vehicles of the NTN system 400 as transmission and/or reception points for transmitting and/or receiving reference signals for positioning the UE 105 (e.g., in addition or as an alternative to TRPs of base stations of a TN). Reference signals may then be used to perform positioning-related measurements, such as AoA, RTT, TDOA, etc., as previously described. A location server (e.g., LMF) communicatively linked with the gateway 420 may be used to coordinate positioning sessions using the UE 105 and one or more of the satellites 410. Relevant references include, for example, Technical References (TR) 38.821 (e.g., section 4) and 38.311 (e.g., section 4.6).

In NTN different beam management applications may be used. For example, for frequency range 1 (FR1), beam management under release 15 (Rel-15) of relevant 3GPP standards may be used. For frequency reuse >1, this may include two possible schemes: (1) where one bandwidth part (BWP) is used for each satellite beam and (2) where one component carrier is used per satellite beam. Further, a mechanism may be introduced in which the both the UL and DL BWPs are switched simultaneously using a single downlink control information (DCI) to support fast satellite beam switching. Here, the concept of BWP can be used for frequency resource allocation among NTN beams, and that the network may configure a specific active BWP for UEs in a beam. Further, in some implementations, the number of BWPs for NTN can be higher than a TN. Note that service link switching may be seen as a part of beam management mechanism in NR NTN.

With respect to polarization in NTN networks, neighboring cells may use different polarization modes (e.g., right-hand circular polarization (RHCP) and left-hand circular polarization (LHCP) determine to mitigate inter-cell interference. Furthermore, there may be UEs with different antenna types. Some UEs may be equipped with linearly polarized antennas, while some other UEs may be equipped with circularly polarized antennas. In an applicable radio resource control (RRC) layer implementation, it may be beneficial to signal the polarization mode for NTN in certain scenarios (e.g., when the UE is capable of differentiating RHCP and LHCP with the circularly or linearly polarized antennas).

As noted, NTN positioning using LEO satellites may be challenging due to the limited visibility of LEO satellites by a UE on earth. In particular, since the UE may only see one or two satellites during a time window, positioning using three or more satellites often may be unfeasible. That said, as communication networks increase the number of LEO said used for NTN, two-satellite visibility is commonly possible. Especially when the UE is under the overlap footprint/service area (for example, during the transition from one satellite to another satellite). Ultimately, the frequency of instances that a UE could observe two satellites is very high in the LEO satellite networks, allowing for possible UE positioning using at least two satellites. As noted, embodiments here are directed toward a technique for positioning using two or more satellites (e.g., LEO satellites) referred to herein as multi-epoch double-differenced ranging (MEDDR).

MEDDR is a relative positioning method using a pair of stationary LEO receivers comprising the target UE and the reference station. Broadly put, according to embodiments herein, the positioning of the target UE using MEDDR may involve determining pseudoranges (estimated distances) from each of two or more satellites for LEO receivers at first and second times, where the LEO receivers comprise the target UE and at least one reference station. Pseudoranges at first and second times can be determined using ranging measurements at those times, using ranging techniques from UL, DL, and/or UL-DL measurements as previously described herein, such as RTT.

Generally put at a time of tᵢ, each of the UE and reference station can measure its respective pseudorange from an LEO satellite 510 as:

$${r}_{j}^{S} ( {t}_{i} ) = {d}_{j}^{S} ( {t}_{i} ) + c ( d {T}^{S} ( {t}_{i} ) + d {T}_{j} ( {t}_{i} ) ) + {A}_{j}^{S} ( {t}_{i} ) + {ε}_{j}^{S} ( {t}_{i} ) , \qquad ( Eqn . 1 )$$

where the subscript j represents an LEO receiver (UE or reference station), the superscript S represents a LEO satellite, c is the speed of light, dT^{S} is satellite clock bias, dTⱼ is receiver clock bias, A is atmospheric ranging offset (e.g., ionosphere, troposphere),

$${ε}_{j}^{S}$$

is the pseudorange noise (e.g., relativity effects, multipath, etc.). The true distance between LEO satellite and receiver,

$${d}_{j}^{S} ,$$

can be written as:

$${d}_{j}^{S} ( {t}_{i} ) = \vert {p}^{S} ( {t}_{i}^{S} ) - {p}_{j} ( {t}_{i} ) \vert , \qquad ( Eqn . 2 )$$

$$where {p}^{S} ( {t}_{i}^{S} )$$

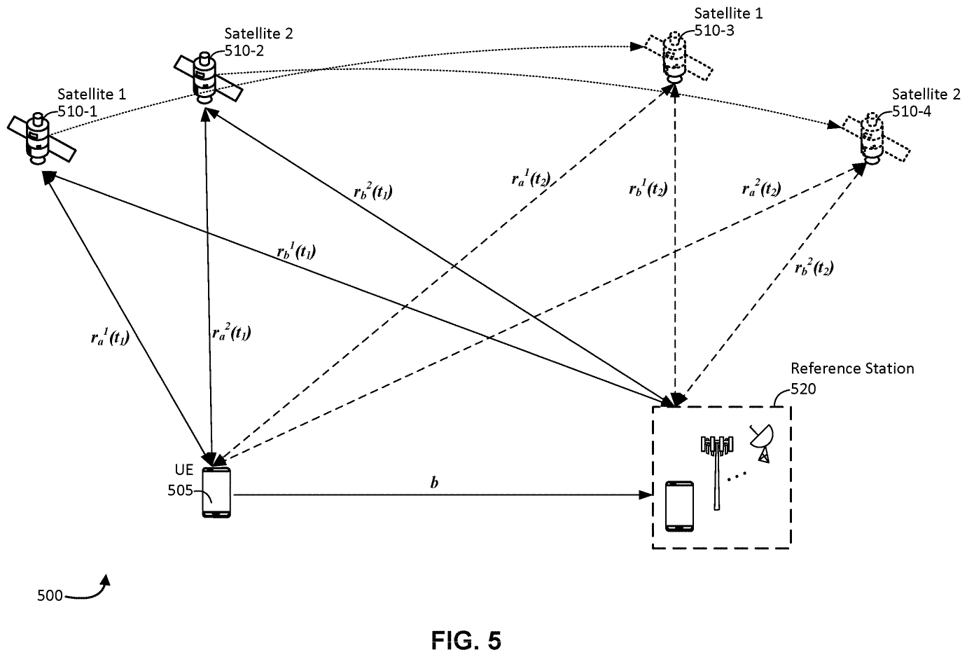

is a LEO satellite position at transmission time, and pⱼ(tᵢ) is a LEO receiver position. An example of this is illustrated in FIG. 5.

FIG. 5 is a diagram of an example configuration 500 in which MEDDR may be performed to determine the location of UE 505 (which may correspond with the UE 105 as described with respect to FIGS. 1-4). In FIG. 5, satellite 510-1 corresponds with a position of the first satellite at a first time t1, satellite 510-2 corresponds with a position of the second satellite at the first time t1, satellite 510-3 corresponds with a position of the first satellite at a second time t2, and satellite 510-4 corresponds with a position of a second satellite at the second time t2. The reference station 520 may comprise any of a variety of types of devices (UE, base station, satellite receiver, and/or other device) and, like the UE 505, is capable of communicating with satellites 510. The reference station 520 may comprise a mobile or stationary device communicatively coupled with the wireless communications network of the satellites 510. According to some embodiments, the reference station 520 may be capable of broadcasting or otherwise directly communicating with the UE 505, however embodiments are not so limited.

As shown in FIG. 5, both the UE 505 and reference station 520 take measurements to determine respective pseudoranges for each of a first satellite 510-1 and the second satellite 510-2 at time t1. Putting these four pseudoranges in the form of Eqn. 1, this results in the following equations:

$$( Eqn . 3 )$$

$${r}_{U E}^{S 1} ( {t}_{1} ) = {d}_{U E}^{S 1} ( {t}_{1} ) + c ( d {T}^{S 1} ( {t}_{1} ) + d {T}_{U E} ( {t}_{1} ) ) + {A}_{U E}^{S 1} ( {t}_{1} ) + {ε}_{U E}^{S 1} ( {t}_{1} ) ,$$

$${r}_{U E}^{S 2} ( {t}_{1} ) = {d}_{U E}^{S 2} ( {t}_{1} ) + c ( d {T}^{S 2} ( {t}_{1} ) + d {T}_{U E} ( {t}_{1} ) ) + {A}_{U E}^{S 2} ( {t}_{1} ) + {ε}_{U E}^{S 2} ( {t}_{1} ) ,$$

$${r}_{r e f}^{S 1} ( {t}_{1} ) = {d}_{r e f}^{S 1} ( {t}_{1} ) + c ( d {T}^{S 1} ( {t}_{1} ) + d {T}_{r e f} ( {t}_{1} ) ) + {A}_{r e f}^{S 1} ( {t}_{1} ) + {ε}_{r e f}^{S 1} ( {t}_{1} ) ,$$

$$and$$

$${r}_{r e f}^{S 2} ( {t}_{1} ) = {d}_{r e f}^{S 2} ( {t}_{1} ) + c ( d {T}^{S 2} ( {t}_{1} ) + d {T}_{r e f} ( {t}_{1} ) ) + {A}_{r e f}^{S 2} ( {t}_{1} ) + {ε}_{r e f}^{S 2} ( {t}_{1} ) .$$

After taking double difference (Δ∇) between both LEO satellites as well as the UE 505 and the reference station 520, ranging errors of dT^{S}, dT_{UE} and

$${A}_{j}^{S}$$

can be removed. Specifically, when UE 505 and reference station 520 are within a threshold distance, atmospheric errors cancel out; receiver clock bias cancels out from to measurements by the same LEO receiver; and satellite clock bias cancels out based on measurements of satellites from the UE 505 and reference station 520. This can leave a double differenced pseudorange defined as the true distance and noise:

$$( Eqn . 4 )$$

$$Δ ∇ r ( {t}_{i} ) ≡ [ {r}_{U E}^{S 1} ( {t}_{i} ) - {r}_{r e f}^{S 1} ( {t}_{i} ) ] - [ {r}_{U E}^{S 2} ( {t}_{i} ) - {r}_{r e f}^{S 2} ( {t}_{i} ) ] = Δ ∇ d ( {t}_{i} ) + Δ ∇ ε ( {t}_{i} ) .$$

When the baseline (distance between UE and reference station (ref)) is short:

$$Δ ∇ d ( {t}_{i} ) = [ l o {s}_{U E}^{S 1} ( {t}_{i} ) - l o {s}_{U E}^{S 2} ( {t}_{i} ) ] \cdot b ( {t}_{i} ) \qquad ( Eqn . 5 )$$

Where b is the relative position vector between UE 505 and reference station 520,

$$b ( {t}_{i} ) = {p}_{r e f} ( {t}_{i} ) - {p}_{U E} ( {t}_{i} ) ,$$

and los is the line-of-sight unit vector between a satellite and receiver.

When UE 505 is stationary (or where movement is otherwise compensated for) during multiple epochs of double difference ranging observation, the following can be determined:

$$[ \begin{matrix}Δ ∇ r ( {t}_{1} ) \\ Δ ∇ r ( {t}_{2} ) \\ ⋮ \\ Δ ∇ r ( {t}_{n} )\end{matrix} ] = [ \begin{matrix}{los}_{UE}^{S 1} ( {t}_{1} ) - {los}_{UE}^{S 2} ( {t}_{1} ) \\ {los}_{UE}^{S 1} ( {t}_{2} ) - {los}_{UE}^{S 2} ( {t}_{2} ) \\ ⋮ \\ {los}_{UE}^{S 1} ( {t}_{n} ) - {los}_{UE}^{S 2} ( {t}_{n} )\end{matrix} ] b + [ \begin{matrix}Δ ∇ ε ( {t}_{1} ) \\ Δ ∇ ε ( {t}_{2} ) \\ ⋮ \\ Δ ∇ ε ( {t}_{n} )\end{matrix} ] \qquad ( Eqn . 6 )$$

Note p_{UE}, p_{ref} and b are constant, so at least three of these linearly independent observations at different times (equations) may be needed to solve the location of the UE 505 in 3D. However, if the altitude of the UE 505 is known (e.g., using a map, sensor, etc.) or not needed, the location of the UE 505 may be determined using only 2 epochs/observations (e.g., at times t1 and t2). Thus, embodiments may use two or more sets of measurements taken at the respective two or more times in order to determine a location of a UE using the Eqn. 6 above.

It can be noted that the satellite position variation between times t1 and t2 help ensure avoid singularity of the least square solutions. Thus, according to embodiments, a threshold amount of time must elapse between times t1 and t2 to help ensure this satellite position variation. For LEO satellites, numerical simulations results showed that a 30-second interval from LEO satellites with an altitude ~300 km can provide reasonable UE positioning accuracy (e.g., on the order of meters) for the baseline length (b) of several km. Depending on desired functionality, the baseline length can be longer when the epoch interval gets longer as well. Thus, embodiments may balance the threshold time duration between times t1 and t2 with a baseline length between the UE 505 and reference station 520, which may be application specific. For example, if the UE 505 is a mobile and is not expected to move for several minutes, it may utilize success of epochs (threshold durations between measurement times) of longer than 30 seconds will allow for longer baseline lengths. Thus, according to some embodiments, the threshold time duration between times t1 and t2 (and subsequent epochs) may be dynamically customized based on LEO satellite orbit, baseline length, and any required accuracy for the UE location estimation (e.g., as defined in a related specification, required by a requesting entity or application, etc.).

Depending on desired functionality, different devices may determine the location of the UE, using MEDDR, as described herein. According to some embodiments, the reference station 520 may provide measurement and location information directly to the UE, as previously noted (e.g., via broadcast and/or other direct wireless transmissions). Additionally or alternatively, the reference station may provide this information to the UE via other devices (e.g., communicating measurement and location information to a server, which may relay this information to the UE). In either of these cases, the UE may then determine its location based on the information from the reference station, satellite location information (e.g., a local model or provided by a server), and measurement information obtained by measurements made at the UE. Additionally or alternatively, the UE may provide information to the reference station in a similar manner, in which case the reference station may determine the location of the UE. According to some embodiments, the UE and reference stations may both send measurement information to a server (e.g., a location server), which may then use that information (and satellite location information) to determine the location of the UE.

Communication in a wireless network of information such as measurement information, configuration information (e.g., configuring the RF signals to be broadcast and measurements to be taken), and so forth, may be governed by a particular wireless communication standard. For example, to support MEDDR using 3GPP, an LMF may provide a UE with assistance data in the manner described above with respect to FIG. 3, communicating with the UE, via one or more base stations and satellites, using LPP to provide assistance data to the UE. According to some embodiments, MEDDR may be supported the LMF in a manner similar to other types of positioning in LPP. For example, treating MEDDR as a different type of positioning method (similar to TDOA, AOD, and the like).

According to embodiments, a new set of assistance data corresponding to a “MEDDR” positioning method may include one or more of the following data. The LMF may provide the UE with information regarding PRS transmitted by satellites, including a pair of PRS (PRS ID) should that are associated with a pair of TRPs (TRP IDs). The two TRP IDs may correspond with the two satellites used for positioning the UE, the satellites transmit the PRS, which are measured by the UE for positioning. It can be noted that the two TRPs (two satellites) may or may not be associated with the same base station (gNB). That is, in some instances, both satellites may be associated with the same base station, where is in other instances each satellite may be associated with a separate base station. In some embodiments, it may be indicated to the UE (e.g., in the assistance data) the associated PRS are used for the MEDDR positioning, so that the UE can could report its Rx-Tx time difference with same pair of PRS used by the reference station.

According to some embodiments, to enhance the accuracy of the double differential-based positioning, the LMF may configure the UL signaling to be transmitted by the UE and reference station (e.g., SRS) close in time/frequency. Again, according to some embodiments, it may be indicated to the UE which SRS is used for the MEDDR measurement, it can allow the UE to conduct the UE Rx-Tx time difference measurement/report with the associated PRS/SRS.

Other features may be used to save power. For example, to save UE power, the PRS configuration could be instance based (e.g., on-demand), rather than a periodical signal (which is the case for traditional PRS). In such embodiments, in each instance, there may be periodical PRS transmitted within some time window. In such embodiments, the time window during which UE can observe two satellites may be limited and predictable. Again, such window narrowing can result in reduced power usage. For each satellite, instances can be time such that, for at least two instances, enough time passes between the first and second instances to avoid singularity of the least square solutions in position estimation, as previously noted.

As previously noted, for UE-based positioning in which the UE determines its location, the location of the reference station can be conveyed to the UE. As previously noted, this may be done by direct communication between the reference station and the UE, or may be done via the LMF (e.g., via satellite-based communication) and/or some other indirect communication means. In some embodiments, for example, a measurement report may be provided to the UE (e.g., directly by the reference station or by an LMF that receives a measurement report from the reference station), and the measurement report may include the location of the reference station.

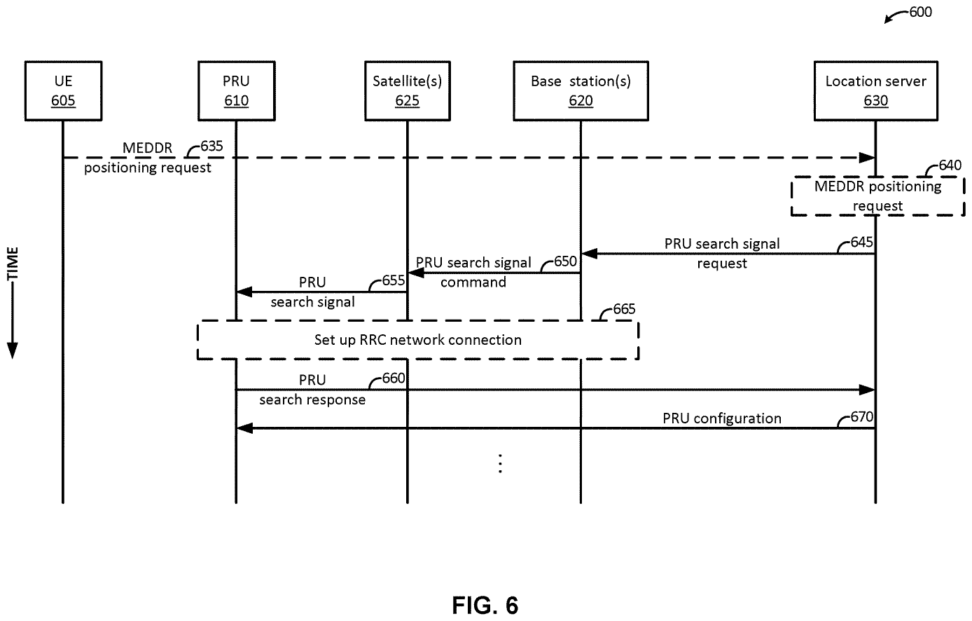

In some embodiments, a reference station may comprise a positioning reference unit (PRU), as defined in relevant 3GPP standards. According to some embodiments, a scheme utilizing a PRU as a reference station may need to define a procedure for MEDDR positioning. An example procedure is illustrated in FIG. 6

FIG. 6 is a message flow diagram of a procedure 600 for supporting MEDDR-based positioning according to an embodiment. In particular, this procedure 600 may be used to determine whether there is an available PRU 610 for performing positioning of the UE 605. As shown, the procedure 600 may be performed by various components of a wireless network, including a UE 605, PRU 610 (which may correspond to a reference station, as described elsewhere herein) one or more base stations 620 (e.g., gNB) which may communicate with the PRUs 610 and/or UE 605 via one or more satellite(s) 625 (e.g., which may include either or both of the satellites used for positioning), and a location server 630 (e.g., LMF). As with other figures provided herein, the operations illustrated in procedure 600 are provided as a nonlimiting example of an embodiment for implementing MEDDR-based positioning. Alternative embodiments may add, omit, rearrange, or otherwise alter operations as illustrated, depending on desired functionality.

The procedure 600 may begin with a MEDDR position request, which may be sent from the UE 605 to the location server, as shown by arrow 635. This may be based, for example, on a request by a user or application of the UE 605. Alternatively the MEDDR position request may be obtained by the location server, as indicated at block 640, based on some other event. The location server 630 may, for example, determined to perform MEDDR positioning of the UE based on received request for the position of the UE 605 from inside the wireless communication network, or from an external client.

Responsive to the request at arrow 635 or block 640, the location server 630 can then send a request to the base station(s) 620 to broadcast a PRU signal, as indicated at arrow 645. This can cause the base station(s) 620 to then send a command to the satellite(s) 625, as indicated at arrow 650, which then transmit/broadcast a PRU search signal, indicated at arrow 655. Upon receiving the PRU search signal, the PRU 610 may then respond to the location server 630, as indicated by arrow 660. As indicated by the optional functionality at block 665, the PRU 610 may need to set up the RRC network connection with the base station(s) 620 before sending the PRU search response.

The PRU search response (sent at arrow 660) may include different types of information, depending on desired functionality. For example, according to some embodiments, the PRU 610 may indicate a device type or category of the UE 610, such as whether the PRU 610 comprises a terrestrial network (TN) base station, a fixed UE, a mobile UE, or the like. Additionally or alternatively, the PRU 610 may report its location.

It can be noted that the selection of the PRU 610 may vary depending on circumstances, capabilities, and/or other factors. For example, in instances in which the position of the UE 605 is entirely unknown, the location server 630 may schedule multiple PRUs to support the MEDDR positioning of the UE 605.) In instances in which the UE's rough location is known, the LMF may select a PRU (e.g., from a plurality of PRUs responding to the PRU search signal sent at arrow 655) with smaller baseline length (the distance from rough location of the UE to the PRU) to support the MEDDR. Furthermore, in some embodiments, the PRU selection may be dynamic changing. For example, in a first instance, a location server 630 may select multiple PRUs (e.g., PRU 1, PRU 2, and PRU 3) to perform MEDDR positioning of the UE 605. However, in a subsequent instance, the location server 630 may only select a single PRU (e.g. PRU 2) based on the minimum baseline length to the UE. What's the PRU 610 is selected, the location server 630 can send the PRU 610 a PRU configuration, as indicated at arrow 670, with information to perform the measurements with the satellite(s) 625 from which the applicable pseudoranges may be determined, as described elsewhere herein.

It can be noted that embodiments herein may provide for a location determination of a target UE, even in cases where the target UE and/or reference station (e.g., PRU) may be moving. That is, referring to the example of FIG. 5 above, the UE 505 and/or reference station 520 may have different respective locations at times t1 and t2. For a moving reference station, the reference station may simply need to provide a respective location for each set of satellite measurements. Differences in baselines may then be compensated for by, for example, modifying Eqn. 6 to account for different baselines at different measurement times. Movement of a UE could be determined based on sensor information and/or other movement sources, and also compensated for. In some embodiments, for example, equations similar to modifying Eqn. 6 may be used to solve for velocity in the Doppler domain. (Again, this can allow for different baselines to be determined and compensated for.) In embodiments in which the UE and/or reference station is moving, the UE and/or reference station may further report motion status and/or real-time location to a location server.

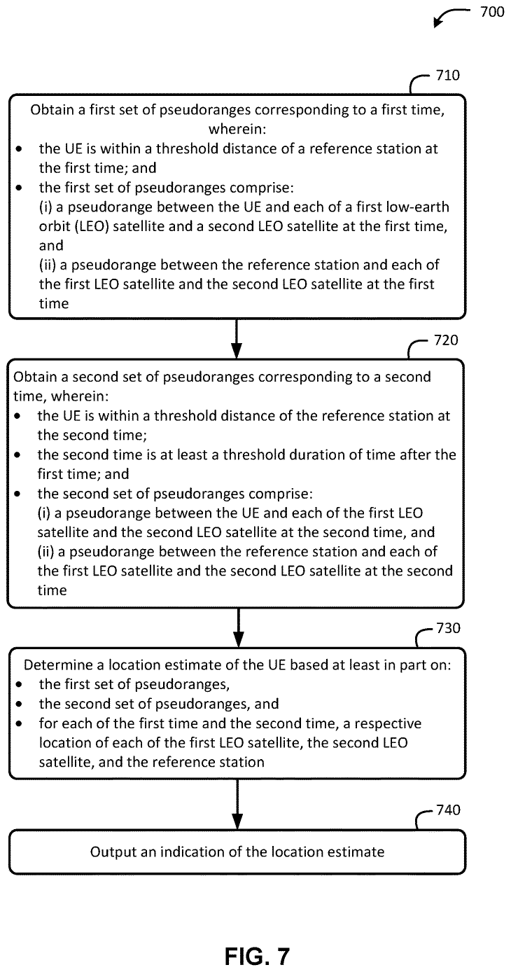

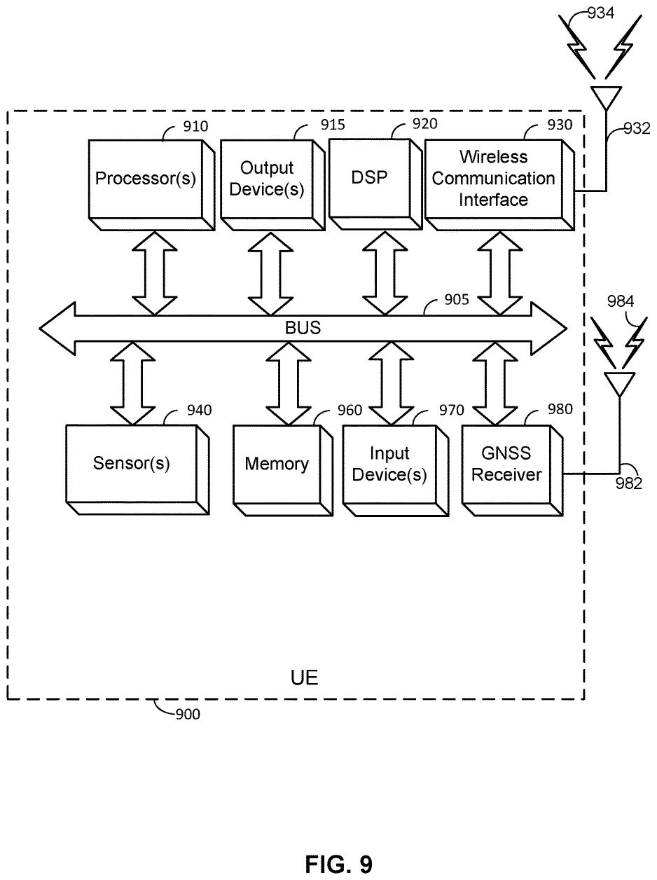

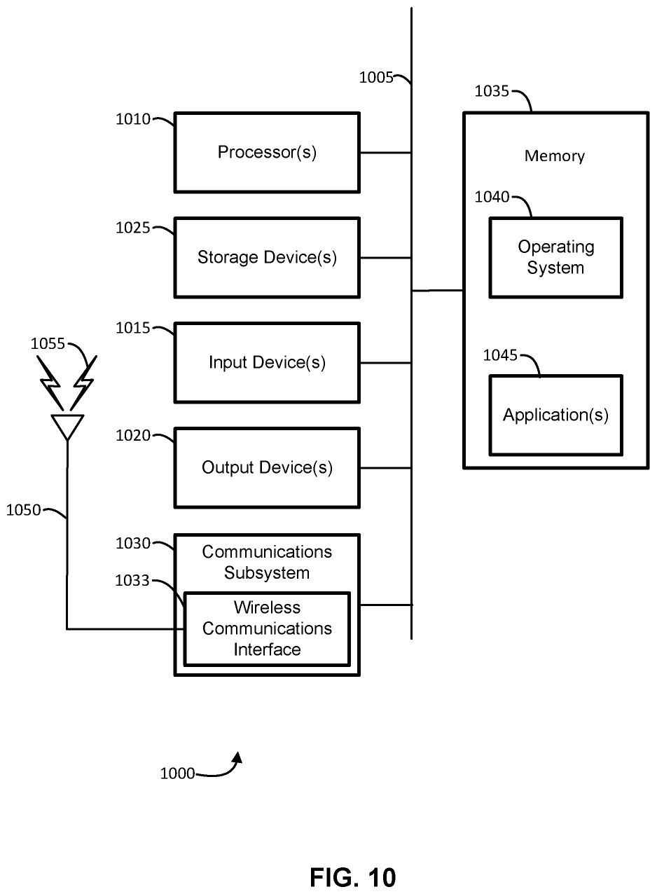

FIG. 7 is a flow diagram of a method 700 of MEDDR for positioning a UE in a wireless communication network, according to an embodiment. Structure/means for performing the functionality illustrated in one or more of the blocks shown in FIG. 7 may be performed by hardware and/or software components of UE, base station, or server (e.g., location server). Example components of a UE are illustrated in FIG. 9, and example components of a computer system capable of performing the functionality for a base station or server are described in FIG. 10, both of which are described in more detail below. In some embodiments, some or all of the operations of the method 700 may be performed in a positioning session (e.g., LPP positioning session) between the UE, a location server, and (optionally) a base station.

At block 710, the functionality comprises obtaining a first set of pseudoranges corresponding to a first time, wherein the UE is within a threshold distance (e.g., a first threshold distance) of a reference station at the first time; and the first set of pseudoranges comprise (i) a pseudorange between the UE and each of a first low-earth orbit (LEO) satellite and a second LEO satellite at the first time, and (ii) a pseudorange between the reference station and each of the first LEO satellite and the second LEO satellite at the first time. With respect to FIG. 5, the functionality at block 710 may correspond to the pseudoranges determined from measurements taken at time t1 by both UE 505 and reference station 520, for example.

Means for performing the functionality at block 710 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 710 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

At block 720, the functionality comprises obtaining a second set of pseudoranges corresponding to a second time, wherein: the UE is within a threshold distance (e.g., a second threshold distance, which may be the same or different than the first threshold distance) of the reference station at the second time, the second time is at least a threshold duration of time after the first time, and the second set of pseudoranges comprise (i) a pseudorange between the UE and each of the first LEO satellite and the second LEO satellite at the second time, and (ii) a pseudorange between the reference station and each of the first LEO satellite and the second LEO satellite at the second time. With respect to FIG. 5, the functionality at block 720 may correspond to the pseudoranges determined from measurements taken at time t2 by both UE 505 and reference station 520, for example.

Means for performing the functionality at block 720 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 720 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

With respect to the functionality at block 720 and 730, embodiments may implement different features, depending on desired functionality. With respect to the measurements taken by the UE and reference station, these measurements may comprise RTT measurements, as described herein, wherein PRS transmitted by satellites are separately measured by the UE and reference station, and each of the UE of reference station may further transmit SRS. The measurements of the PRS and transmission of the SRS, by the UE and/or reference station, may be in accordance with a configuration received by a location server. This configuration information to be provided in assistance data from the location server.

At block 730, the functionality comprises determining a location estimate of the UE based at least in part on: the first set of pseudoranges, the second set of pseudoranges, and for each of the first time and the second time, a respective location of each of the first LEO satellite, the second LEO satellite, and the reference station. As noted herein, the location of the reference station may be communicated by the reference station to a location server, UE, or other device determining the location of the UE. Location information of area satellites may be obtained from relevant ephemeris, geometrical models, and/or other information sources capable of providing satellite location information and the measured times.

Means for performing the functionality at block 730 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 730 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

At block 740, the functionality comprises outputting an indication of the location estimate. This indication may be provided within a device (e.g., from one component or application to another), at a user interface (e.g., to a user of the device), transmitted to a separate device, or any combination thereof. Thus, according to some embodiments, outputting an indication of the location estimate may comprise providing the indication with a user interface, communicating the indication to a device, providing the indication to an application layer of a device, providing the indication to a hardware component within a device, or any combination thereof

Means for performing the functionality at block 740 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 740 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

As noted in the embodiments described previously, one or more additional features may be implemented, depending on desired functionality. For example, according to some embodiments, determining a location estimate may comprise taking a double difference for each of the first set of pseudoranges and the second set of pseudoranges. As shown in Eqn. 4, the double difference for the first set of pseudoranges a map comprise a difference between: (i) a difference between the pseudoranges of each of the UE and the reference station with the first LEO satellite at the first time, and (ii) a difference between the pseudoranges of each of the UE and the reference station with the second LEO satellite at the first time; and the double difference for the second set of pseudorange measurements comprises a difference between: (i) a difference between the pseudoranges of each of the UE and the reference station with the first LEO satellite at the second time, and (ii) a difference between the pseudoranges of each of the UE and the reference station with the second LEO satellite at the second time. Additionally or alternatively, embodiments may comprise determining the threshold duration of time based on an estimated distance of the UE from the reference station. According to some embodiments, the threshold duration of time is at least 30 seconds. In some embodiments, determining the location estimate of the UE a comprise compensating for movement of the UE between the first time and the second time. Additionally or alternatively, some embodiments may further comprise, prior to obtaining the first set of pseudoranges and obtaining the second set of pseudoranges, sending a request for positioning of the UE using MEDDR (e.g., as indicated at arrow 635 and block 640 in a FIG. 6).

As noted, the method 700 may be performed by different devices, depending on desired functionality. For example, according to some embodiments, the method is performed by the UE or the reference station. In such embodiments, the method may further comprise receiving assistance data from a server, in which case obtaining the first set of pseudoranges and obtaining the second set of pseudoranges may comprise, at least in part, performing pseudorange measurements in accordance with the assistance data. In such cases, the assistance data may comprise an identifier of a PRS to measure for a pseudorange measurement, a configuration of an SRS to transmit for a pseudorange measurement, or a combination thereof. In some instances, the method may be performed by a server or base station of the wireless communication network. In such cases, obtaining the first set of pseudoranges and obtaining the second set of pseudoranges may respectively comprise receiving the first set of pseudoranges and the second set of pseudoranges from the UE, the reference station, or both. Moreover, in such embodiments, obtaining the first set of pseudoranges and obtaining the second set of pseudoranges may comprise determining the first set of pseudoranges and the second set of pseudoranges from pseudorange measurements received from the UE, the reference station, the first LEO satellite, the second LEO satellite, or any combination thereof. Additionally or alternatively, methods may comprise, prior to obtaining the first set of pseudoranges and obtaining the second set of pseudoranges, obtaining a location of the reference station.

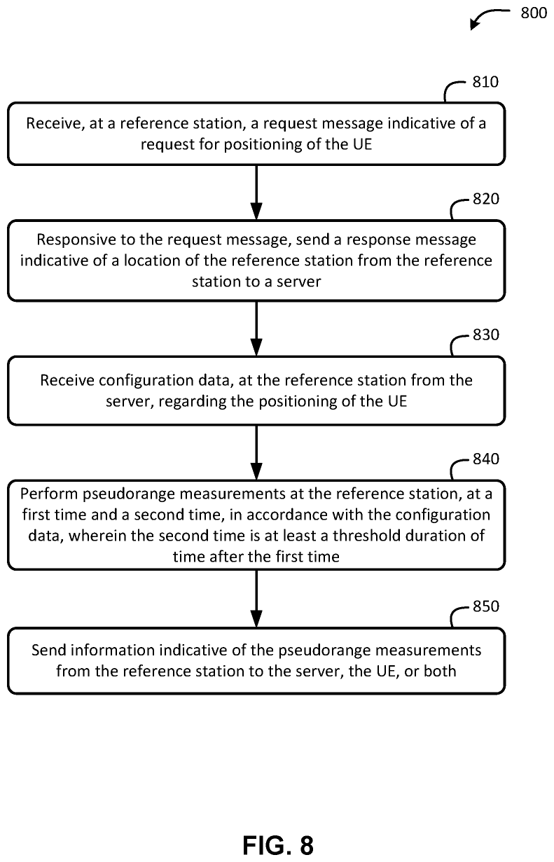

FIG. 8 is a flow diagram of a method 800 of supporting MEDDR for positioning a UE in a wireless communication network, according to an embodiment. Aspects of the method 800 may reflect the functionality of a reference station (or PRU) as described in the embodiments herein. Structure/means for performing the functionality illustrated in one or more of the blocks shown in FIG. 8 may be performed by hardware and/or software components of UE, base station, or other device acting as a reference station. Example components of a UE are illustrated in FIG. 9, and example components of a computer system capable of performing the functionality for a base station or other device are described in FIG. 10, both of which are described in more detail below. In some embodiments, some or all of the operations of the method 800 may be performed in a positioning session (e.g., LPP positioning session) between the UE, a location server, and (optionally) a base station.

At block 810, the functionality comprises receiving, at a reference station, a request message indicative of a request for positioning of the UE. As noted with respect to arrow 655 of FIG. 6, this request may come in the form of a PRU search signal, which may be transmitted by one or more satellites in an effort to determine available reference stations (PRUs) to use for positioning the UE. According to some embodiments, the search signal may be provided at certain intervals and/or scheduled times, to enable the reference station to detect in the PRU search signal.

Means for performing the functionality at block 810 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 810 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

At block 820, the functionality comprises responsive to the request message, send a response message indicative of a location of the reference station from the reference station to a server. As noted with respect to the PRU search response at arrow 660 of FIG. 6, a reference station may provide various information in a PRU search response, including the location of the PRU. As noted, this may be used by the location server to determine whether a UE is within a threshold distance (e.g., based on a rough location of the UE) from the reference station (e.g., as a baseline length within the threshold distance) and/or compare the reference station with other candidate reference stations to determine which may be the best for positioning the UE (e.g., which candidates may have the shortest baseline lengths). As previously indicated, a response to a request message may include a device type of the reference station. According to some embodiments, the device type of the reference station may comprise a terrestrial base station, a fixed UE, or a mobile UE, and wherein the method further comprises including, in the response message, the device type of the reference station.

As noted, a reference station may need to set up an RRC network connection with a base station in order to response to a request. That is, the reference station may not have previously connected with the wireless network of the base station prior to receiving the request. As such, some embodiments may further comprise, responsive to the request message and prior to sending the response message, establishing an RRC connection with the wireless communication network.

Means for performing the functionality at block 820 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 820 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

At block 830, the functionality comprises receiving configuration data, at the reference station from the server, regarding the positioning of the UE. As noted with respect to arrow 665 in FIG. 6, that configuration data received from the location server may include information to enable the reference station to perform measurements of RF signals transmitted by satellites for pseudorange determination. As such, they configuration data may include information regarding signals transmitted by the satellites (e.g., PRS information including frequency and/or timing information).

Means for performing the functionality at block 830 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 830 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

At block 840, the functionality comprises performing pseudorange measurements at the reference station, at a first time and a second time, in accordance with the configuration data, wherein the second time is at least a threshold duration of time after the first time. As noted elsewhere herein, the threshold duration of time may vary, depending on the baseline length, accuracy requirements for the estimated UE location, and/or other such factors.

Means for performing the functionality at block 840 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 840 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

At block 850, the functionality comprises sending information indicative of the pseudorange measurements from the reference station to the server, the UE, or both. Here, the device to which of the reference station sends the pseudorange measurements may depend on which device initiated the positioning. For a UE-based positioning, the reference station may send the information to the UE. On the other hand, for network-based positioning (UE-assisted positioning) the reference station may send the information to the location server. This information can include, for example, the pseudorange measurements, pseudorange is determined using the pseudorange measurements, or a combination thereof.

Means for performing the functionality at block 850 may comprise a bus 905, processor(s) 910, digital signal processor (DSP) 920, wireless communication interface 930, memory 960, other components of a UE 900 as illustrated in FIG. 9, or any combination thereof. Additionally or alternatively, means for performing functionality at block 850 may comprise a bus 1005, one or more processors 1010, one or more storage devices 1025, one or more input devices 1015, a communications subsystem 1030 (which may include wireless communications interface 1033), a memory 1035 (which may include an operating system 1040 and/or one or more applications 1045), other components of a computer system 1000 as illustrated in FIG. 10, or any combination thereof.

As noted, embodiments may compensate for movement by the UE and/or reference station between measurements (e.g., times t1 and t2). As such, the reference station may send a server update of location information. Thus, some embodiments may further comprise sending, to the server, an indication of an updated location of the reference station, wherein the updated location of the reference station is indicative of a location of the reference station at the second time.

FIG. 9 is a block diagram of an embodiment of a UE 900, which can be utilized as described herein. For example, UE 900 may correspond with the target UE for which MEDDR positioning is performed and/or for a reference station comprising a UE. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The UE 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 900 to communicate with other devices as described in the embodiments above. The wireless communication interface 930 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The UE 900 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000@, WCDMA, and so on. CDMA2000@includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 910 or DSP 920.

The UE 900 may further include and/or be in communication with a memory 960. The memory 960 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 900 (and/or processor(s) 910 or DSP 920 within UE 900). In some embodiments, then, such code and/or instructions can be used to configure and/or adapt a general-purpose computer (or other device) to perform one or more operations in accordance with the described methods.

FIG. 10 is a block diagram of an embodiment of a computer system 1000, which may be used, in whole or in part, to provide the functions of one or more components and/or devices as described in the embodiments herein. The computer system 1000, for example, may be utilized within/executed by a server (e.g., location server/LMF) and/or reference station (e.g., base station/gNB) as described herein. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers that may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network, including UE, base stations and/or other transmission reception points (TRPs), satellites, and/or any other electronic devices described herein. Hence, the communications subsystem 1030 may be used to receive and send data as described in the embodiments herein.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of multi-epoch double-differenced ranging (MEDDR) for positioning a user equipment (UE) in a wireless communication network, the method comprising: obtaining a first set of pseudoranges corresponding to a first time, wherein: the UE is within a threshold distance (e.g., a first threshold distance) of a reference station at the first time; and the first set of pseudoranges comprise: a pseudorange between the UE and each of a first low-earth orbit (LEO) satellite and a second LEO satellite at the first time, and a pseudorange between the reference station and each of the first LEO satellite and the second LEO satellite at the first time; obtaining a second set of pseudoranges corresponding to a second time, wherein: the UE is within a threshold distance (e.g., a second threshold distance) of the reference station at the second time; the second time is at least a threshold duration of time after the first time; and the second set of pseudoranges comprise: a pseudorange between the UE and each of the first LEO satellite and the second LEO satellite at the second time, and a pseudorange between the reference station and each of the first LEO satellite and the second LEO satellite at the second time; determining a location estimate of the UE based at least in part on: the first set of pseudoranges, the second set of pseudoranges, and for each of the first time and the second time, a respective location of each of the first LEO satellite, the second LEO satellite, and the reference station; and outputting an indication of the location estimate.

Clause 2. The method of clause 1, wherein determining a location estimate comprises taking a double difference for each of the first set of pseudoranges and the second set of pseudoranges.

Clause 3. The method of clause 2 wherein the double difference for the first set of pseudoranges comprises a difference between: a difference between the pseudoranges of each of the UE and the reference station with the first LEO satellite at the first time, and a difference between the pseudoranges of each of the UE and the reference station with the second LEO satellite at the first time; and the double difference for the second set of pseudorange measurements comprises a difference between: a difference between the pseudoranges of each of the UE and the reference station with the first LEO satellite at the second time, and a difference between the pseudoranges of each of the UE and the reference station with the second LEO satellite at the second time.

Clause 4. The method of any one of clauses 1-3 further comprising determining the threshold duration of time based on an estimated distance of the UE from the reference station.

Clause 5. The method of any one of clauses 1-4 wherein the threshold duration of time is at least 30 seconds.

Clause 6. The method of any one of clauses 1-5 wherein the method is performed by the UE or the reference station.

Clause 7. The method of clause 6 further comprising receiving assistance data from a server, and wherein obtaining the first set of pseudoranges and obtaining the second set of pseudoranges comprise, at least in part, performing pseudorange measurements in accordance with the assistance data.

Clause 8. The method of clause 7 wherein the assistance data comprises: an identifier of a positioning reference signal (PRS) to measure for a pseudorange measurement, a configuration of a sounding reference signal (SRS) to transmit for a pseudorange measurement, or a combination thereof.

Clause 9. The method of any one of clauses 1-5 wherein the method is performed by a server or base station of the wireless communication network.

Clause 10. The method of clause 9 wherein obtaining the first set of pseudoranges and obtaining the second set of pseudoranges respectively comprise receiving the first set of pseudoranges and the second set of pseudoranges from the UE, the reference station, or both.

Clause 11. The method of clause 9 wherein obtaining the first set of pseudoranges and obtaining the second set of pseudoranges comprise determining the first set of pseudoranges and the second set of pseudoranges from pseudorange measurements received from the UE, the reference station, the first LEO satellite, the second LEO satellite, or any combination thereof.

Clause 12. The method of any one of clauses 9-11 further comprising, prior to obtaining the first set of pseudoranges and obtaining the second set of pseudoranges, obtaining a location of the reference station.

Clause 13. The method of any one of clauses 1-12 wherein determining the location estimate of the UE comprises compensating for movement of the UE between the first time and the second time.

Clause 14. The method of any one of clauses 1-13 wherein outputting an indication of the location estimate comprises: providing the indication with a user interface, communicating the indication to a device, providing the indication to an application layer of a device, providing the indication to a hardware component within a device, or any combination thereof.

Clause 15. The method of any one of clauses 1-14 further comprising, prior to obtaining the first set of pseudoranges and obtaining the second set of pseudoranges, sending a request for positioning of the UE using MEDDR.

Clause 16. A method of supporting multi-epoch double-differenced ranging (MEDDR) for positioning a user equipment (UE) in a wireless communication network, the method comprising: receiving, at a reference station, a request message indicative of a request for positioning of the UE; responsive to the request message, sending a response message indicative of a location of the reference station from the reference station to a server; receiving configuration data, at the reference station from the server, regarding the positioning of the UE; performing pseudorange measurements at the reference station, at a first time and a second time, in accordance with the configuration data, wherein the second time is at least a threshold duration of time after the first time; and sending information indicative of the pseudorange measurements from the reference station to the server, the UE, or both.

Clause 17. The method of clause 16, wherein the information indicative of the pseudorange measurements comprises: the pseudorange measurements, pseudoranges determined using the pseudorange measurements, or a combination thereof.

Clause 18. The method of any one of clauses 16-17 wherein a device type of the reference station comprises a terrestrial base station, a fixed UE, or a mobile UE, and wherein the method further comprises including, in the response message, the device type of the reference station.

Clause 19. The method of any one of clauses 16-18 further comprising, responsive to the request message and prior to sending the response message, establishing a radio resource control (RRC) connection with the wireless communication network.

Clause 20. The method of any one of clauses 16-19 further comprising sending, to the server, an indication of an updated location of the reference station, wherein the updated location of the reference station is indicative of a location of the reference station at the second time.

Clause 21. A device for multi-epoch double-differenced ranging (MEDDR) for positioning a user equipment (UE) in a wireless communication network, the device comprising: a memory; and one or more processors communicatively coupled with the memory, wherein the one or more processors are configured to: obtain a first set of pseudoranges corresponding to a first time, wherein: the UE is within a threshold distance of a reference station at the first time; and the first set of pseudoranges comprise: a pseudorange between the UE and each of a first low-earth orbit (LEO) satellite and a second LEO satellite at the first time, and a pseudorange between the reference station and each of the first LEO satellite and the second LEO satellite at the first time; obtain a second set of pseudoranges corresponding to a second time, wherein: the UE is within a threshold distance of the reference station at the second time; the second time is at least a threshold duration of time after the first time; and the second set of pseudoranges comprise: a pseudorange between the UE and each of the first LEO satellite and the second LEO satellite at the second time, and a pseudorange between the reference station and each of the first LEO satellite and the second LEO satellite at the second time; determine a location estimate of the UE based at least in part on: the first set of pseudoranges, the second set of pseudoranges, and for each of the first time and the second time, a respective location of each of the first LEO satellite, the second LEO satellite, and the reference station; and output an indication of the location estimate.

Clause 22. The device of clause 21, wherein the device comprises the UE or the reference station, and further comprises a transceiver, and wherein: the one or more processors are further configured to receive assistance data from a server, and to obtain the first set of pseudoranges and to obtain the second set of pseudoranges, the one or more processors are configured to perform pseudorange measurements, with the transceiver, in accordance with the assistance data.

Clause 23. The device of clause 21 wherein the method is performed by a server or base station of the wireless communication network.

Clause 24. The device of clause 23 wherein, to obtain the first set of pseudoranges and obtaining the second set of pseudoranges respectively, the one or more processors are configured to receive the first set of pseudoranges and the second set of pseudoranges from the UE, the reference station, or both.

Clause 25. The device of any one of clauses 21-24 wherein, to determine the location estimate of the UE, the one or more processors are configured to compensate for movement of the UE between the first time and the second time.

Clause 26. A reference station for supporting multi-epoch double-differenced ranging (MEDDR) for positioning a user equipment (UE) in a wireless communication network, the reference station comprising: a transceiver; a memory; and one or more processors communicatively coupled with the transceiver and the memory, wherein the one or more processors are configured to: receive, via the transceiver, a request message indicative of a request for positioning of the UE; responsive to the request message, send a response message indicative of a location of the reference station via the transceiver to a server; receive configuration data, via the transceiver from the server, regarding the positioning of the UE; perform pseudorange measurements with the transceiver, at a first time and a second time, in accordance with the configuration data, wherein the second time is at least a threshold duration of time after the first time; and send information indicative of the pseudorange measurements from via the transceiver to the server, the UE, or both.

Clause 27. The reference station of clause 26, wherein the one or more processors are configured to include, in the information indicative of the pseudorange measurements: the pseudorange measurements, pseudoranges determined using the pseudorange measurements, or a combination thereof.

Clause 28. The reference station of any one of clauses 26-27 wherein a device type of the reference station comprises a terrestrial base station, a fixed UE, or a mobile UE, and wherein the one or more processors are further configured to include, in the response message, the device type of the reference station.

Clause 29. The reference station of any one of clauses 26-28 wherein the one or more processors are further configured to, responsive to the request message and prior to sending the response message, establish a radio resource control (RRC) connection with the wireless communication network.

Clause 30. The reference station of any one of clauses 26-29 wherein the one or more processors are further configured to send, via the transceiver to the server, an indication of an updated location of the reference station, wherein the updated location of the reference station is indicative of a location of the reference station at the second time.

Clause 31. An apparatus having means for performing the method of any one of clauses 1-20.

Clause 32. A non-transitory computer-readable medium storing instructions, the instructions comprising code for performing the method of any one of clauses 1-20.

What is claimed is:

1. A method of supporting multi-epoch double-differenced ranging (MEDDR) to position a user equipment (UE) in a wireless communication network, the method comprising:
receiving a request message at a reference station, the request message indicative of a request for positioning of the UE;
sending a response message from the reference station to a server, responsive to the request message, the response message comprising a location of the reference station;
receiving configuration data at the reference station, the configuration data received from the server and regarding the positioning of the UE;
performing pseudorange measurements at the reference station, the pseudorange measurements performed at a first time and a second time, in accordance with the configuration data, wherein the second time is at least a threshold duration of time after the first time; and
sending information indicative of the pseudorange measurements from the reference station to the server, the UE, or both.

2. The method of claim 1, wherein the information indicative of the pseudorange measurements comprises:
the pseudorange measurements,
pseudoranges determined using the pseudorange measurements, or
a combination thereof.

3. The method of claim 1, wherein a device type of the reference station comprises a terrestrial base station, a fixed UE, or a mobile UE, and wherein the method further comprises including, in the response message, the device type of the reference station.

4. The method of claim 1, further comprising, responsive to the request message and prior to sending the response message, establishing a radio resource control (RRC) connection with the wireless communication network.

5. The method of claim 1, further comprising sending, to the server, an indication of an updated location of the reference station, wherein the updated location of the reference station is indicative of a location of the reference station at the second time.

6. The method of claim 1, wherein the request message comprises a positioning reference unit (PRU) search signal.

7. The method of claim 1, wherein the configuration data comprises information regarding a positioning reference signal (PRS) transmitted by one or more satellites for the pseudorange measurements.

8. The method of claim 1, wherein the threshold duration of time is based on a baseline length between the reference station and the UE, an orbit of a satellite used for the pseudorange measurements, an accuracy requirement for a location estimate of the UE, or a combination thereof.

9. The method of claim 1, wherein the server comprises a location management function (LMF).

10. A reference station for supporting multi-epoch double-differenced ranging (MEDDR) to position a user equipment (UE) in a wireless communication network, the reference station comprising:
a transceiver;
a memory; and
one or more processors communicatively coupled with the transceiver and the memory, wherein the one or more processors are configured to:
receive a request message via the transceiver at the reference station, the request message indicative of a request for positioning of the UE;
send a response message via the transceiver to a server, responsive to the request message, the response message comprising a location of the reference station;
receive configuration data via the transceiver at the reference station, the configuration data received from the server and regarding the positioning of the UE;
perform pseudorange measurements with the transceiver, the pseudorange measurements performed at a first time and a second time, in accordance with the configuration data, wherein the second time is at least a threshold duration of time after the first time; and
send information indicative of the pseudorange measurements via the transceiver to the server, the UE, or both.

11. The reference station of claim 10, wherein the one or more processors are configured to include, in the information indicative of the pseudorange measurements:
the pseudorange measurements,
pseudoranges determined using the pseudorange measurements, or
a combination thereof.

12. The reference station of claim 10, wherein a device type of the reference station comprises a terrestrial base station, a fixed UE, or a mobile UE, and wherein the one or more processors are further configured to include, in the response message, the device type of the reference station.

13. The reference station of claim 10, wherein the one or more processors are further configured to, responsive to the request message and prior to sending the response message, establish a radio resource control (RRC) connection with the wireless communication network.

14. The reference station of claim 10, wherein the one or more processors are further configured to send, via the transceiver to the server, an indication of an updated location of the reference station, wherein the updated location of the reference station is indicative of a location of the reference station at the second time.

15. The reference station of claim 10, wherein the request message comprises a positioning reference unit (PRU) search signal.

16. The reference station of claim 10, wherein the configuration data comprises information regarding a positioning reference signal (PRS) transmitted by one or more satellites for the pseudorange measurements.

17. The reference station of claim 10, wherein the threshold duration of time is based on a baseline length between the reference station and the UE, an orbit of a satellite used for the pseudorange measurements, an accuracy requirement for a location estimate of the UE, or a combination thereof.

18. The reference station of claim 10, wherein the server comprises a location management function (LMF).

19. An apparatus for supporting multi-epoch double-differenced ranging (MEDDR) to position a user equipment (UE) in a wireless communication network, the apparatus comprising:
means for receiving a request message at a reference station, the request message indicative of a request for positioning of the UE;
means for sending a response message from the reference station to a server, responsive to the request message, the response message comprising a location of the reference station;
means for receiving configuration data at the reference station, the configuration data received from the server and regarding the positioning of the UE;
means for performing pseudorange measurements at the reference station, the pseudorange measurements performed at a first time and a second time, in accordance with the configuration data, wherein the second time is at least a threshold duration of time after the first time; and
means for sending information indicative of the pseudorange measurements from the reference station to the server, the UE, or both.

20. The apparatus of claim 19, wherein the apparatus comprises the reference station, and wherein the reference station comprises a transceiver, a memory, and one or more processors communicatively coupled with the transceiver and the memory.
